(19) United States
(12) Patent Application Publication
(10) Pub. No.: US 2025/0306809 A1
(43) Pub. Date: Oct. 2, 2025

(54) IMAGE FORMING DEVICE OBTAINING EXTERNALLY CONFIGURABLE PARAMETER FROM EXTERNAL DEVICE AND OBTAINING INTERNALLY CONTROLLED PARAMETER FROM STORAGE

(71) Applicant: BROTHER KOGYO KABUSHIKI KAISHA, Nagoya (JP)

(72) Inventors: Masashi OHHASHI, Kasugai (JP); Satoru ARAKANE, Nagoya (JP); Koichi TSUGIMURA, Nagoya (JP); Naoyuki NAKAMURA, Nagoya (JP); Haruka AZECHI, Nagoya (JP); Yasuhiro NAKANO, Nagoya (JP)

(21) Appl. No.: 19/057,077

(22) Filed: Feb. 19, 2025

(30) Foreign Application Priority Data
Mar. 26, 2024 (JP) 2024-049873

(51) Int. Cl. G06F 3/12

(52) U.S. Cl. CPC G06F 3/1204; G06F 3/1254

(57) ABSTRACT

A controller of an image forming device receives user-identification information through a user interface or from an external device. The controller performs a parameter obtaining process including obtaining a plurality of setting parameters each of which has a corresponding value. Here, the controller obtains an externally configurable parameter from the external device. The externally configurable parameter is a parameter that is one of the plurality of setting parameters and is configurable by the external device to have a value. The controller obtains an internally controlled parameter from ta storage based on the user-identification information. The internally controlled parameter is a parameter that is one of the plurality of setting parameters, is associated with the user-identification information, and is configurable by the controller but not configurable by the external device. The controller performs an image forming process using the image forming engine based on the plurality of setting parameters.

### REFERENCE TO RELATED APPLICATIONS

This application claims priority from Japanese Patent Application No. 2024-049873 filed on Mar. 26, 2024. The entire content of the priority application is incorporated herein by reference.

### BACKGROUND ART

Conventionally, an image forming device such as a printer may receive settings from a PC or other external device related to the paper to be used in image formation, and the image forming quality, and may perform image forming operations in accordance with these settings. Any settings that are not configurable in the printer driver of this external device can be set through a control panel provided on the image forming device for each individual print job, i.e., each time an image forming operation is performed.

### SUMMARY

Thus, settings that cannot be configured on a conventional external device must be configured on the image forming device each time an image forming operation is performed. Consequently, the user is forced to modify settings for each job, even though such modifications should be unnecessary for settings that have already been configured once.

In view of the foregoing, it is an object of the present disclosure to provide an image forming device that allows the configuration of settings that are not configurable on an external device, without resulting in a loss of convenience.

In order to attain the above and other objects, the present disclosure provides an image forming device. The image forming device includes an image forming engine, a user interface, a storage, and a controller. The controller is configured to perform: receiving user- identification information through the user interface or from an external device; a parameter obtaining process including obtaining a plurality of setting parameters each of which has a corresponding value, the obtaining in the parameter obtaining process including: obtaining an externally configurable parameter from the external device, the externally configurable parameter being a parameter that: is one of the plurality of setting parameters; and is configurable by the external device to have a value; and obtaining an internally controlled parameter from the storage based on the user-identification information, the internally controlled parameter being a parameter that: is one of the plurality of setting parameters; is associated with the user-identification information; and is configurable by the controller but not configurable by the external device; and an image forming process using the image forming engine based on the plurality of setting parameters.

In the above structure, the internally controlled parameter having the value that cannot be configured by the external device is stored in the storage in association with user-identification information. The controller obtains the internally controlled parameter from the storage based on the user identification information obtained through the user interface and performs the image forming process according to the internally controlled parameter having the value. Thus, it is unnecessary that the user inputs a value for the internal controlled parameter repeatedly for each image forming process. It is also unnecessary that a user modifies main device settings shared by users. Accordingly, a loss of convenience can be avoided.

### BRIEF DESCRIPTION OF DRAWINGS

FIG. 1 is a schematic diagram illustrating configurations of a printer and an external device.

FIG. 2 is a conceptual diagram illustrating relations between types of printer drivers and configurability of settings for setting items concerning image formation using the printer shown in FIG. 1.

FIG. 3 is a conceptual diagram illustrating content stored in a storage of the printer shown in FIG. 1.

FIG. 4 is a flowchart illustrating a process performed by a control device in the printer shown in FIG. 1.

FIG. 5 is an explanatory diagram illustrating a screen displayed in S3 of the process described in FIG. 4.

FIG. 6 is an explanatory diagram illustrating a screen displayed in S5 of the process described in FIG. 4.

FIG. 7 is an explanatory diagram illustrating a screen displayed in S6 of the process described in FIG. 4.

FIG. 8 is an explanatory diagram illustrating a screen displayed in S8 of the process described in FIG. 4.

FIG. 9 is a schematic diagram illustrating configurations of a printer and an external device.

### DESCRIPTION

### First Embodiment

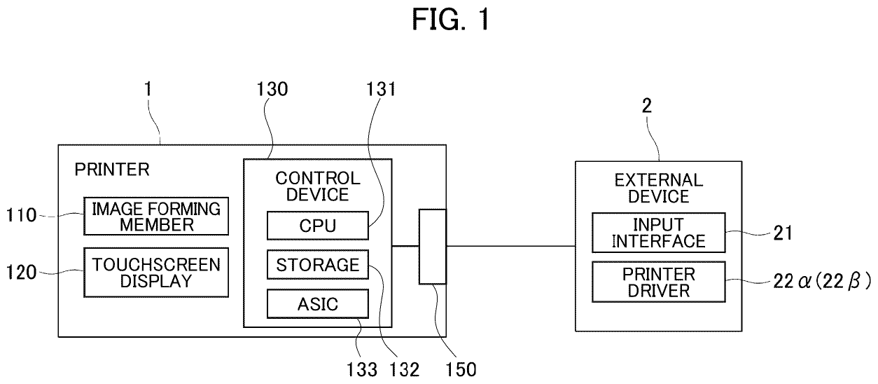

A printer 1 according to a first embodiment will be described with reference to FIGS. 1 through 8. As shown in FIG. 1, the printer 1 has an image forming member 110, a touchscreen display 120, a communication interface 150, and a control device 130. The printer 1 corresponds to the image forming device.

The image forming member 110 performs image forming operations to form images on printing paper based on image data received from an external device 2 described later. That is, the image forming member 110 is a print engine for printing an image on a sheet. The image forming member 110 has a print head that deposits ink on printing paper, and a conveying member that conveys the printing paper relative to the print head. The image forming member 110 executes an image forming operation with the conveying member conveying printing paper while the print head deposits ink on the printing paper.

The image forming member 110 performs image forming operations based on content set for various settings. Here, settings include setting items and corresponding values. However, the term “settings” may refer either the setting items or the values assigned thereto, depending on the context in which the term “settings” is used. The setting items may be referred to as setting parameters indicating variables to which setting values can be assigned or configured. The content of the settings includes values corresponding to the setting items. Or, the content of settings may include the setting parameters with values assigned or configured thereto. The settings include the size and type of paper to be used in image formation, the quality of image formation, and the amount of ink to be used.

The touchscreen display 120 has a screen for displaying text images and the like. A settings screen (or settings area) and the like containing control images for user input are displayed on this screen. The touchscreen display 120 can receive user input through this screen. When the screen is contacted by a finger or other object, the touchscreen display 120 detects the contact position and outputs detection results to the control device 130, thereby enabling the control device 130 to obtain various user input through screens displayed on the touchscreen display 120. The touchscreen display 120 corresponds to an input interface and a user interface. The process to obtain the user input through the touchscreen display 120 corresponds to the process of obtaining.

The control device 130 has hardware and software. The hardware includes a central processing unit (CPU) 131, a storage 132, and an application-specific integrated circuit (ASIC) 133. The storage 132 includes a read-only memory (ROM), and a random-access memory (RAM). The software includes various data including program data stored in the storage 132. In addition to the program data, data stored in the storage 132 includes the content of various settings related to image forming operations, and image data. The control device 130 or the CPU 131 executes various processes through the cooperation of this hardware and software. The control device 130 and the CPU 131 are examples of the controller or the processor.

The communication interface 150 is a network interface communicable with external devices. The communication interface 150 may be configured of a wired or wireless LAN interface. The communication interface 150 may be a universal serial bus (USB) interface conforming to the USB standard. The printer 1 is connected to an external device 2 through the communication interface 150 and can perform data communications with the external device 2. The printer 1 may connects to a network via the communication interface 150. The external device 2 may be a computer, such as a laptop computer, a desktop computer, or a smartphone. The external device 2 has an input interface (or user interface) 21, and a printer driver 22α or 22β. The input interface 21 comprises a keyboard, mouse, touchscreen display, and the like that can receive user input. Each of the printer drivers 22α and 22β is program data for utilizing functions of the printer 1. The present embodiment has two types of printer drivers, one of them being the printer driver 22α and the other being the printer driver 22β. However, other types of drivers supporting the printer 1 may be installed and used in the external device 2.

Through the functions of a printer driver, the external device 2 can obtain or acquire information needed by the image forming member 110 to perform image forming operations. This information includes the image data to be used in image formation, and the content for various settings related to image forming operations (hereinafter referred to as “externally configurable settings” or “external settings”). That is, the externally configurable settings include one or more setting parameter(s) to which the printer driver as well as the printer 1 can assign corresponding values. The external device 2 transmits this obtained information to the printer 1.

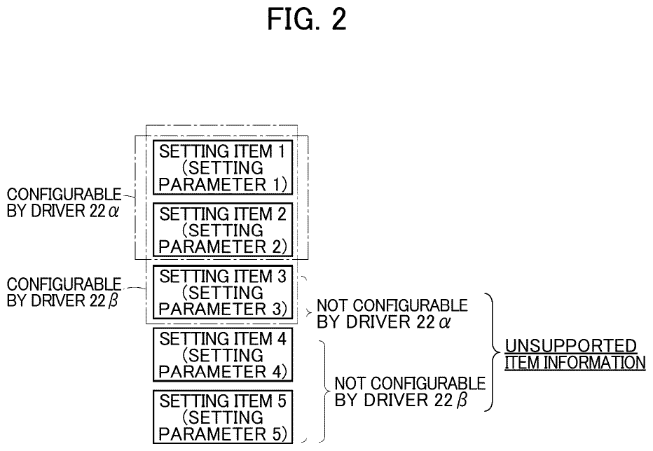

The externally configurable settings that can be obtained or acquired through functions of a printer driver differ according to the type of printer driver. According to one example shown in FIG. 2, the printer driver 22α can set or configure setting values for two of the five setting items 1-5: setting items 1 and 2. The printer driver 22β can set or configure setting values for three of the five setting items 1-5: setting items 1-3. Conversely, the printer driver 22α cannot set or configure any of setting values for items 3-5, while the printer driver 22β cannot set or configure any of setting values for items 4 and 5. Hereinafter, items that cannot be set or configured in a printer driver will be called “driver-unsupported items,” and information specifying driver-unsupported items for each printer driver will be called “unsupported item information.”

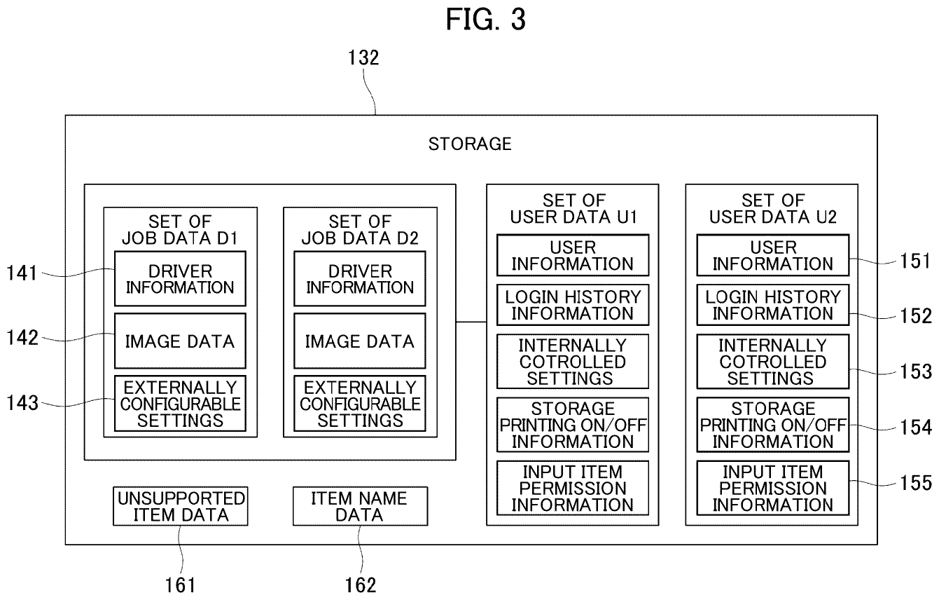

When the printer 1 obtains or acquires image data and externally configurable settings from the external device 2 through the communication interface 150, the CPU 131 of the printer 1 stores this image data and setting content in the storage 132 as job data. This process corresponds to the parameter acquisition process or the parameter obtaining process and an example of the process of obtaining the externally configurable parameter. When the printer 1 obtains or acquires image data and externally configurable settings from the external device 2 through the communication interface 150 multiple times in succession, the CPU 131 accumulates a plurality of sets of job data in the storage 132, as illustrated by the job data D1 and D2 in FIG. 3. The CPU 131 then executes an image forming process in which the image forming member 110 is controlled to execute an image forming operation in accordance with each set of job data.

As described above, some of the various setting items related to an image forming operation can be set or configured through the functions of a printer driver in the external device 2, but the remaining items, i.e., the driver-unsupported items, cannot be configured through the functions of the printer driver on the external device 2. Therefore, when the printer 1 executes an image forming operation based solely on the externally configurable settings received from the external device 2 through the communication interface 150, the operation may not reflect settings for the driver-unsupported items. However, it is conceivable that settings for the driver-unsupported items could be configured on the printer 1 side. For example, it is conceivable to save settings for image forming operations in advance as the printer's main device settings in order that these settings can be used thereafter by default. However, when the image forming device is employed by multiple users, all users would be sharing one set of main device settings under this conceivable method. In such cases, the main device settings might need to be frequently modified by users, which can lead to a loss of convenience.

In order to suppress such loss of convenience, the present embodiment employs a configuration in the printer 1 to manage settings for each user, as will be described below.

As shown in FIG. 3, the storage 132 of the printer 1 stores unsupported item data 161, and item name data 162. Table 1 below illustrates one example of the unsupported item data 161. In this example, the unsupported item data 161 specifies the unsupported item information associated with each type of printer driver. Table 1 corresponds to the sample of the unsupported item data 161 shown in FIG. 2. The item name data 162 is character string data specifying the names of various setting items related to image forming operations.

TABLE 1

| Type of Driver | Unsupported item information |
|---|---|
| 22α | 3, 4, and 5 |
| 22β | 4 and 5 |

The storage 132 also stores sets of user data for individual users (user accounts). The information specified by each set of user data U1 and U2 includes user information 151, login history information 152, internally controlled settings (internal settings) 153, storage printing on/off information 154, and input item permission information 155. The user information 151 is identification information of the user. The login history information 152 indicates the user's login history on the printer 1, as will be described later. The internally controlled settings 153 specify a setting value for each of the driver-unsupported items. The internally controlled settings 153 may include a setting value for each of the printer driver supported items described in the unsupported item data 161. In this case, the internally controlled settings 153 includes the setting value for each of the printer driver supported items may be the driver supported item associated with any of the drivers (22α and 22β in this example). Alternatively, the internally controlled settings 153 may include a setting value for each of the printer driver supported items related to the user of the corresponding set of user data. In this case, the internally controlled settings 153 includes the setting value for each of the printer driver supported items may be the driver supported item associated with any of the drivers that the user uses with external device(s) of the user. Each item in the internally controlled settings 153 is set to a default value in the initial state. The storage printing on/off information 154 indicates whether a storage printing mode described later has been enabled or disabled. The input item permission information 155 is status information indicating for each driver-unsupported item whether user input is enabled or disabled.

When transmitting image data and/or externally configurable settings to the printer 1, the external device 2 also transmits driver information indicating the type of the printer driver and user identification information to the printer 1. Upon receiving information from the external device 2 through the communication interface 150, the CPU 131 of the printer 1 stores this information in the storage 132 as a set of job data while associating the set of job data with both the user identification information and a set of user data corresponding to the user identification information. As shown in FIG. 3, job data includes driver information 141, image data 142, and externally configurable settings 143 obtained or acquired from the external device 2. When the CPU 131 receives information from the external device 2 through the communication interface 150 a plurality of times in succession, the CPU 131 accumulates this information in the storage 132 as job data D1, job data D2, . . . . The driver information 141 is information specifying the type of the driver that has generated the job data (image data and externally configurable settings) in which the driver information 141 is contained.

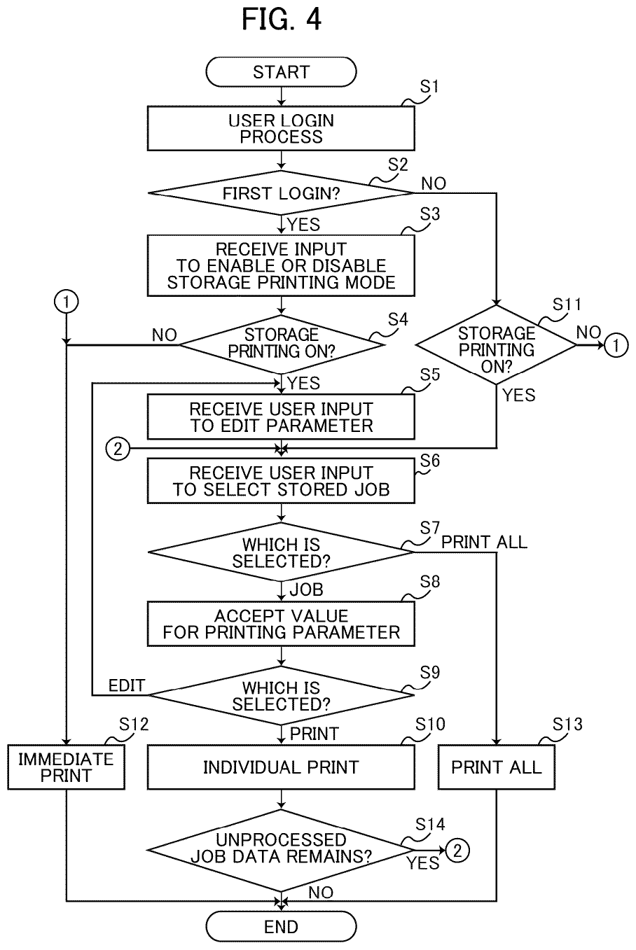

The CPU 131 of the printer 1 executes the process shown in FIG. 4. In S1 at the beginning of this process, the CPU 131 performs a user login process. In this process, the CPU 131 obtains or acquires user identification information in response to user input on the touchscreen display 120. In S2 the CPU 131 determines whether the user specified by the identification information obtained or acquired in S1 is logging in for the first time. The CPU 131 makes this determination based on login history information 152 contained in user data stored in the storage 132 associated with the identification information obtained or acquired in S1. At the same time, the CPU 131 adds information indicating the current login to the login history information 152 in the storage 132. In subsequent steps, the job data will refer to the data associated with the identification information obtained or acquired in S1.

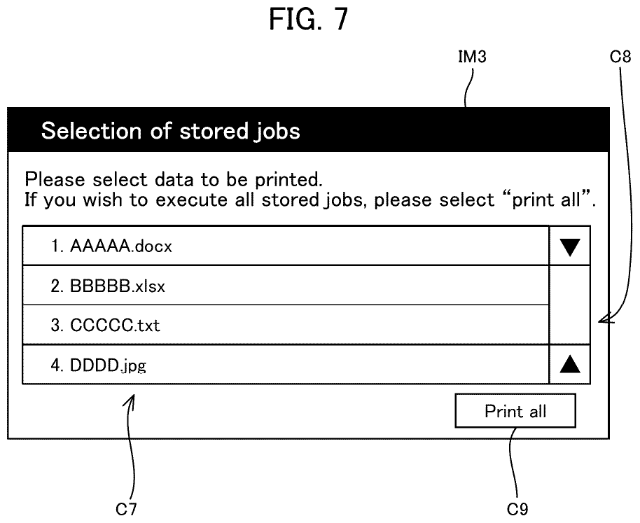

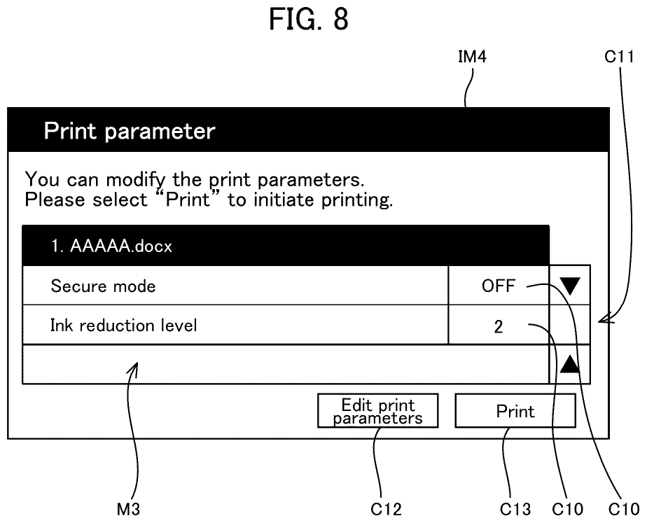

When the CPU 131 determines that the user is logging in for the first time (S2: YES), in S3 the CPU 131 accepts user input to enable or disable a storage printing mode. Storage printing is an image forming process performed on some or all of sets of job data that have been stored and accumulated in the storage 132. In the storage printing, the image forming process begins after the CPU 131 receives an instruction to begin image formation from a user in response to user input via the touchscreen display 120. As will be described below, storage printing corresponds to a series of processes performed in S13 after a control image C9 has been selected in the screen shown in FIG. 7 through user input in a stored job selection process of S6, and a series of processes performed in S10 after a control image C13 has been selected in the screen shown in FIG. 8 through user input in a printing parameter editing process of S8. The storage printing corresponds to a storage-based image formation process. The instruction to begin the image formation in the stored printing is an example of the storage image formation instruction.

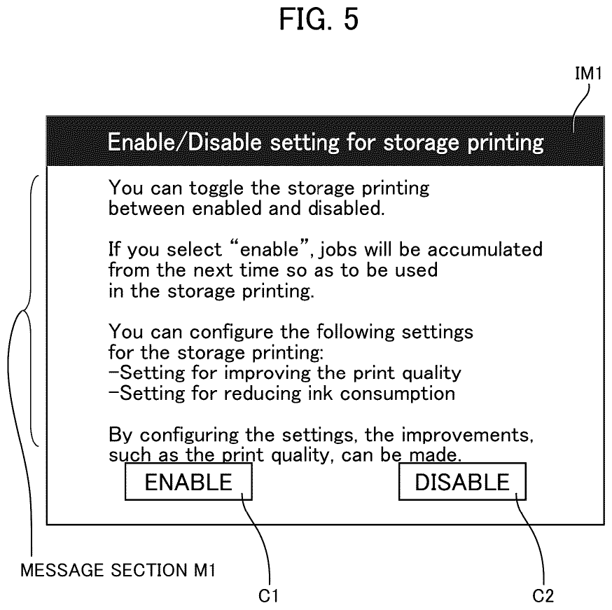

In S3 the CPU 131 displays a “Toggle storage printing” screen IM1 shown in FIG. 5 on the touchscreen display 120. The “Toggle storage printing” screen IM1 prompts the user to select the status of whether the mode for executing storage printing is enabled or disabled. A “stored job” shown in the screen IM1 denotes job data based on which image formation is to be performed as a storage printing. The screen IM1 includes a message section M1, and button-like control images C1 and C2. The message section M1 includes character strings providing a description of how to perform user input via the “Toggle storage printing” screen IM1 and indicating what settings can be configured for a stored job. The control image C1 can be selected through user input on the touchscreen display 120 to enable the storage printing mode. The control image C2 can also be selected through user input on the touchscreen display 120 to disable the storage printing mode.

Specifically, the CPU 131 updates stored content in the storage 132, as described below, according to which of the control images C1 and C2 has been selected. This process corresponds to the process of storing status information. When the control image C1 is selected, the CPU 131 sets the storage printing on/off information 154 (see FIG. 3) contained in a set of user data associated with the identification information obtained or acquired in S1 to “on” indicating the storage printing is enabled. When the control image C2 is selected, on the other hand, the CPU 131 sets the storage printing on/off information 154 to “off” indicating the storage printing is disabled.

The user input to select either the control image C1 or C2 corresponds to the user input to select the status of whether to enable or disable the storage image formation process. The process for receiving this user input by the CPU 131 corresponds to the process of receiving the initial input value or the input value. The user input to select the control image C1 corresponds to the user input to select the status to enable the stored image formation process.

In S4 the CPU 131 determines whether the storage printing mode is enabled based on the stored content in the storage 132. Specifically, the CPU 131 determines whether the storage printing on/off information 154 in the set of user data associated with the identification information obtained or acquired in S1 is “on”. When the CPU 131 determines that the storage printing mode is off (S4: NO), in S12 the CPU 131 performs an immediate print to sequentially execute image forming processes for job data stored in the storage 132. In an immediate print, the CPU 131 uses the internally controlled settings 153 included in the set of user data associated with the identification information obtained or acquired in S1 and the externally configurable settings 143 in the job data, as the content (setting values) for the various setting items related to image forming operations. Subsequently, the CPU 131 ends the process of FIG. 4. The process to obtain the internally controlled settings 153 based on the identification information corresponds to the process of obtaining the internally controlled parameter.

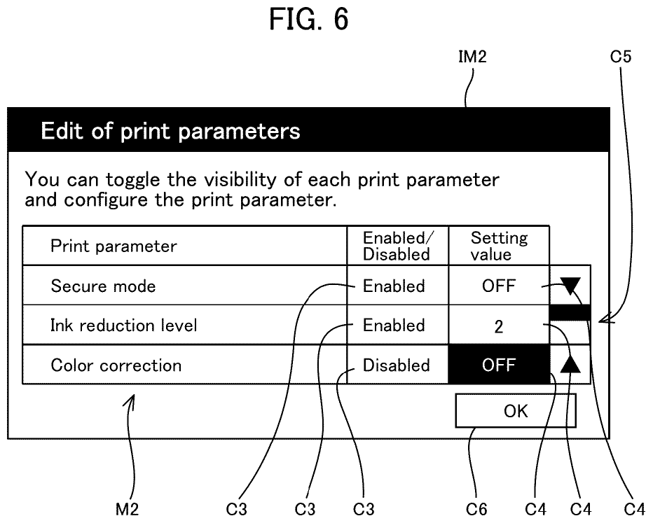

However, when the CPU 131 determines that the storage printing mode is on (S4: YES), in S5 the CPU 131 accepts user input to edit printing parameters. Specifically, the CPU 131 displays an “Edit printing parameters” screen IM2 shown in FIG. 6 on the touchscreen display 120. The “Edit printing parameters” screen IM2 enables the user to edit setting content for driver-unsupported items. That is, the “Edit printing parameters” screen IM2 enables the user to modify setting values assigned to the parameters corresponding to the driver-unsupported items. For this purpose, the CPU 131 obtains or acquires unsupported item information on driver-unsupported items from the unsupported item data 161 in the storage 132 that corresponds to the printer driver specified by the driver information 141 in the relevant job data stored in the storage 132. The process to obtain the unsupported item information on driver-unsupported items corresponds to the process of obtaining the classification information.

The screen IM2 includes a list image M2 showing driver-unsupported items, and control images C3-C6. The list image M2 includes at least a portion of a list of names for the driver-unsupported items specified in the unsupported item information acquired by the CPU 131. This list of names is obtained or acquired from the names of setting items specified in the item name data 162 stored in the storage 132. The control image C5 is a scroll bar image that is operated through user input on the touchscreen display 120. By operating the control image C5, the user can change the range of names in the list that is visible in the list image M2. The list image M2 includes control images C3 each of which corresponds to a driver-unsupported item and allows the user to select the status of whether to enable or disable user input to configure a value for the driver-unsupported item. The user can toggle the status between “enable” and “disable” through user input on the touchscreen display 120. The list image M2 further includes control images C4 each of which corresponding to a driver-unsupported item and allows the user to input a setting value for the driver-unsupported item through user input on the touchscreen display 120. Note that the user can only input setting values in control images C4 for which the corresponding control images C3 are set to “enable.”

The control image C6 is a button-like image that can be selected through user input on the touchscreen display 120. When the control image C6 is selected, the CPU 131 updates the stored content in the storage 132 based on the settings modified in the control images C3 and C4. Specifically, the CPU 131 updates the internally controlled settings 153 and input item permission information 155 (see FIG. 3) included in the set of user data associated with the identification information obtained or acquired in S1. The CPU 131 updates a setting value for each driver-unsupported item in the internally controlled settings 153 to indicate the setting value inputted through the corresponding control image C4. The series of processes to receive user input through the control image C4 and update the setting value in the internally controlled settings 153 in the memory 131 corresponds to the process of obtaining the value of the internally controlled parameter. The CPU 131 updates the status indicating whether user input is enabled or disabled for each driver-unsupported item in the input item permission information 155 to reflect the “enable” or “disable” setting inputted through the corresponding control image C3. This update process corresponds to the process of updating the status information.

In S6 the CPU 131 accepts user input for selecting stored jobs. Specifically, the CPU 131 displays a “Select stored jobs” screen IM3 shown in FIG. 7 on the touchscreen display 120. The “Select stored jobs” screen IM3 allows a user to select a set of job data stored in the storage 132. The screen IM3 includes control images C7-C9. The control image C7 shows at least a portion of the list of job data as a list of the original file names for that job data. Each set of job data in the list can be selected through user input on the touchscreen display 120. The selection of job data using the control image C7 corresponds to the designation of the set of the image data. The control image C8 is a scroll bar that can be operated through user input on the touchscreen display 120. By operating the control image C8, the user can change the range of sets of job data in the list that is visible in the control image C7. The control image C9 can be selected through user input on the touchscreen display 120 in order to execute image formation on all job data. Receiving the selection of the control image C9 by the user input through the touchscreen display 120 corresponds to receiving the execution instruction to form an image in the storage-based image formation.

In S7 the CPU 131 determines whether the control image C9 has been selected in S6 through user input in the “Select stored jobs” screen IM3. When the control image C9 has been selected (S7: print all), in S13 the CPU 131 prints all sets of job data stored in the storage 132. In other words, the CPU 131 sequentially performs an image forming process on each set of job data. At this time, the CPU 131 uses the internally controlled settings 153 included in the set of user data associated with the identification information obtained or acquired in S1 and the externally configurable settings 143 in the job data as settings for the various setting items related to each image forming process. After an image forming process is completed for each set of job data, the CPU 131 deletes the job data from the storage 132. Subsequently, the CPU 131 ends the process in FIG. 4.

When the user selected a specific set of job data in the control image C7 in S6 through user input in the “Select stored jobs” screen IM3 (S7: job), in S8 the CPU 131 accepts values for printing parameters inputted by the user for that job data. Specifically, the CPU 131 displays a “Printing parameters” screen IM4 shown in FIG. 8 on the touchscreen display 120. The “Printing parameters” screen IM4 allows the user to input different settings than the internally controlled settings 153 for the job data selected in S6. The “Printing parameters” screen IM4 includes a list image M3 with a list of setting items, and control images C10-C13. The list image M3 shows at least a portion of the list of driver-unsupported items that have been set to “enable” in the input item permission information 155. The CPU 131 obtains or acquires the name for each driver-unsupported item to be displayed in the list from the item name data 162 stored in the storage 132. The list image M3 includes control images C10 each of which corresponds to a driver-unsupported item and shows the setting value of the driver-unsupported item in the internally controlled settings 153 stored in the storage 132. The setting value for each control image C10 can be selected through user input on the touchscreen display 120. After selecting a displayed setting value, the user can input or select a value different from the setting value specified in the internally controlled settings 153 through the touchscreen display 120. Even when such a value different from that in the internally controlled settings 153 is inputted or selected, the internally controlled settings 153 stored in the storage 132 is not updated. However, the internally controlled settings 153 may be updated based on the inputted value different from that in the internally controlled settings 153. The control image C11 is a scroll bar operated through user input on the touchscreen display 120. By operating the control image C11, the user can change the range of driver-unsupported items that is visible in the list image M3. The control image C12 can be selected through user input on the touchscreen display 120 in order to edit the printing parameters. The control image C13 can be selected through user input on the touchscreen display 120 in order to start image formation for the set of job data selected in S6.

Receiving the selection of the control image C13 by the user input through the touchscreen display 120 corresponds to receiving the execution instruction to form an image in the storage-based image formation. The selection of the control image C13 upon input of at least one setting value different from the setting value in the internally controlled settings 153 corresponds to the modification input.

In S9 the CPU 131 determines whether one of the control images C12 and C13 has selected in S8 through user input in the “Printing parameters” screen IM4. When the CPU 131 determines that the control image C12 has been selected in the “Printing parameters” screen IM4 (S9: edit), the CPU 131 returns to S5 and repeats the process described above. However, when the CPU 131 determines that the control image C13 has been selected in the “Printing parameters” screen IM4 (S9: print), in S10 the CPU 131 executes an individual print on the set of job data that has been selected in S6. In other words, an image forming process is performed on the set of job data selected in S6. In this image forming process, the CPU 131 uses the externally configurable settings 143 in the set of job data for setting items other than the driver-unsupported items. When, for one or more driver-unsupported items, one or more setting values have been inputted by the user in S8 that differ from the setting values in the internally controlled settings 153, the CPU 131 also uses these one or more setting values inputted by the user in S8 that differ from the setting values in the internally controlled settings 153 for the one or more driver-unsupported items. Additionally, the CPU 131 uses the internally controlled settings 153 in the set of user data associated with the identification information obtained or acquired in S1 for the other driver-unsupported items whose setting values have not been changed in S8. Once the image forming process is completed, the CPU 131 deletes this set of job data from the storage 132.

In S14 the CPU 131 determines whether any unprocessed job data remains in the storage 132, i.e., whether there is any set of job data for which an image forming process has not been completed. When the CPU 131 determines that an unprocessed set of job data remains (S14: YES), the CPU 131 returns to S6 and repeats the process described above. When the CPU 131 determines that no unprocessed set of job data remains (S14: NO), the CPU 131 ends the process in FIG. 4.

Further, when the CPU 131 determines in S2 that the user is not logging in for the first time (S2: NO), in S11 the CPU 131 determines whether the storage printing mode is enabled based on the stored content in the storage 132. Specifically, the CPU 131 determines whether the storage printing on/off information 154 included in the set of user data associated with the identification information obtained or acquired in S1 is “on”. The CPU 131 determines whether to execute storage printing as described below based on the determination in S11. When the CPU 131 determines that the storage printing mode is off (S11: NO), the CPU 131 determines that storage printing will not be executed and performs an immediate print in S12. However, when the CPU 131 determines that the storage printing mode is on (S11: YES), the CPU 131 determines that storage printing will be executed and performs the process described above from S6. The process of S11 corresponds to the process of determining.

According to the embodiment described above, the internally controlled settings 153, which are the content of settings (setting values) for driver-unsupported items that cannot be configured with the printer driver of the external device 2, are stored in the storage 132. Here, the internally controlled settings 153 are included in the set of user data associated with identification information for the user. The CPU 131 obtains or acquires internally controlled settings 153 stored in the storage 132 based on the user identification information obtained or acquired through user input on the touchscreen display 120 and executes an image forming operation according to these internally controlled settings 153. When no changes are needed at this time, the CPU 131 performs the image forming operation using the previously set internally controlled settings 153 as is. Accordingly, the user is not forced to input settings for the driver-unsupported items before each image formation and need not modify the main device settings or the like shared with other users, thereby avoiding a loss of convenience.

In the above embodiment, unsupported item information related to driver-unsupported items is stored in association with each printer driver type as the unsupported item data 161. This information is designed to address the issue of identifying what setting values for setting items can be configured for the external device 2. This issue arises because the configurable setting parameters varies depending on the type of printer driver (see FIG. 2). Accordingly, the CPU 131 can easily obtain or acquire unsupported item information using the driver information 141 that has been obtained or acquired from the external device 2 through the communication interface 150 together with the externally configurable settings 143 based on the unsupported item data 161.

Once the storage printing mode has been set on or off through the process in S3 of FIG. 4 in the above embodiment, in S11 for second and subsequent storage printings the CPU 131 automatically determines from that setting whether to execute storage printing. Accordingly, this configuration improves convenience for the user.

In the above embodiment, the CPU 131 can select one set of job data stored in the storage 132 based on the user input through the process of S6 in FIG. 4 and execute an image forming process in the process of S8 so that the external device 2 controls an image forming operation using different settings from the values specified in the internally controlled settings 153.

In the above embodiment, when the user inputs different setting values from the values specified by the internally controlled settings 153 through the process of S8 in FIG. 4, the CPU 131 can only accept changes to a value only for each driver-unsupported item for which the status indicate that user input to configure or modify the value is enabled in the input item permission information 155. Here, the input item permission information 155 has been updated during the process of S5. Accordingly, this configuration improves user convenience by not accepting input for unnecessary items.

In the above embodiment, when the input item permission information 155 is configured in the process of S5 in FIG. 4, user input is also accepted for setting values for driver-unsupported items. Accordingly, this configuration further improves user convenience.

In the above embodiment, the user can select either the control image C12 for editing printing parameters or the control image C13 for starting a storage printing in the process of S8 in FIG. 4 (see FIG. 8). This allows driver-unsupported items to be edited again (in the process of S5) prior to beginning a storage printing.

### Second Embodiment

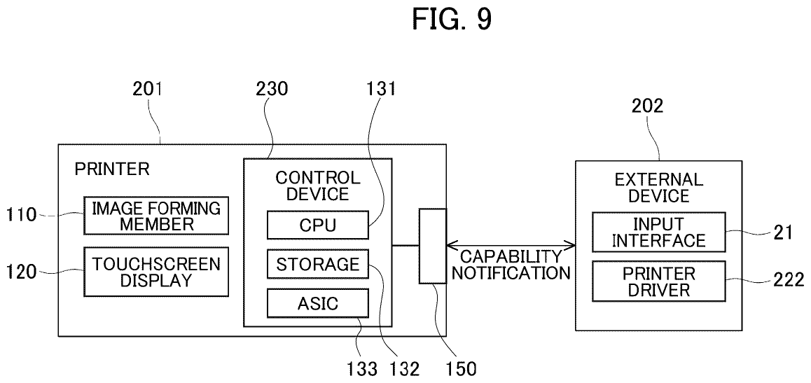

Next, a second embodiment of the disclosure will be described with reference to FIG. 9. A printer 201 and an external device 202 according to the second embodiment have mostly common configurations with the printer 1 and external device 2 described in the first embodiment. Therefore, the following description of the printer 201 and external device 202 will primarily cover differences from the printer 1 and external device 2. Further, common configurations in the printer 201 and external device 202 will be assigned the same reference numerals used in the first embodiment, and descriptions of these configurations will be omitted as appropriate.

In the second embodiment, the main difference from the first embodiment is the method of obtaining unsupported item information. The second embodiment employs a method based on a capability notification exchanged in a communication between the printer 201 and the external device 202 in place of or in addition to the method of using the unsupported item data 161 described in the first embodiment. The capability notification is a communication performed between the printer 201 and external device 202 prior to the external device 202 transmitting job data to the printer 201. This communication is carried out for the purpose of exchanging information related to the settings supported on the printer 201, and the settings that can be configured with a printer driver 222 of the external device 202. Through this communication, he CPU 131 of a control device 230 in the printer 201 can directly obtain or acquire from the external device 202 settings that the external device 202 cannot configure through the functions of the printer driver 222, i.e., unsupported item information for driver-unsupported items. The remaining configurations in the second embodiment are identical to those in the first embodiment.

In addition to the effects described in the first embodiment, the second embodiment enables the CPU 131 of the printer 201 to configure settings related to driver-unsupported items based on unsupported item information obtained or acquired directly from the external device 202.

### Variations of the Embodiments

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, in each of the above embodiments, the driver-unsupported items can be set or modified through user input on the touchscreen display 120 of the printer 1. However, user input on the input interface 21 of the external device 2 may be used in place of this user input. This method to use the user input on the input interface 21 corresponds to the input acquisition process or the input obtaining process. In this case, the external device 2 may transmit the results of user input on the input interface 21 to the printer 1 so that the CPU 131 of the printer 1 can obtain or acquire these results. As an example, the user may employ an application to operate the printer 1 remotely from the external device 2. Here, this application is a program different from a printer driver. This application may enable the user to perform remote operations on the external device 2 that are similar to the various operations performed on the printer 1 through user input on the touchscreen display 120, for example. The above-described process in which the CPU 131 obtain or acquire the results of the user input from the external device 2 corresponds to the process of receiving inputs through the user interface.

In the above embodiment, once the storage printing mode has been set (enabled) in the process of S3 in FIG. 4, this setting is not modified during the remainder of the process in FIG. 4. Therefore, in addition to the embodiment described above, the CPU 131 may display a settings screen that allows the user to edit user data directly through input on the touchscreen display 120 similarly to the screen shown in FIG. 6. This configuration allows the internally controlled settings 153, storage printing on/off information 154, and input item permission information 155 to be set directly for each user. This content may also be set remotely from the external device 2 according to the functions of the above-described application.

The image forming member 110 according to the embodiment described above performs image forming operations by depositing ink on printing paper. This ink deposition may be achieved using the inkjet method or the thermal transfer method. Alternatively, rather than depositing ink on printing paper, the present invention may be applied to a multifunction peripheral or an image forming device having a laser image forming engine that performs image forming operations by depositing toner on printing paper.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. An image forming device comprising:
an image forming engine;
a user interface;
a storage; and
a controller configured to perform:
receiving user-identification information through the user interface or from an external device;
a parameter obtaining process including obtaining a plurality of setting parameters each of which has a corresponding value, the obtaining in the parameter obtaining process including:
obtaining an externally configurable parameter from the external device, the externally configurable parameter being a parameter that: is one of the plurality of setting parameters; and is configurable by the external device to have a value; and
obtaining an internally controlled parameter from the storage based on the user-identification information, the internally controlled parameter being a parameter that: is one of the plurality of setting parameters; is associated with the user-identification information; and
is configurable by the controller but not configurable by the external device; and
an image forming process using the image forming engine based on the plurality of setting parameters.

2. The image forming device according to claim 1, wherein the controller is configured to further perform:
obtaining parameter classification information, the parameter classification information identifying the internally controlled parameter from among the plurality of setting parameters; and
receiving an input value through the user interface in association with the user-identification information to store the input value in the storage as a value of the internally controlled parameter that is identified in the parameter classification information and is associated with the user-identification information.

3. The image forming device according to claim 2, wherein the controller is configured to further perform:
obtaining type information from the external device, the type information indicating a type of a program, the program being installed in the external device and for configuring the externally configurable parameter on the external device,
wherein the controller performs the obtaining the parameter classification information by obtaining the parameter classification information associated with the type information in the storage.

4. The image forming device according to claim 2, wherein the controller performs the obtaining the parameter classification information by obtaining the parameter classification information from the external device.

5. The image forming device according to claim 1, wherein the image forming process includes:
a storage-based image forming process including:
receiving one or more sets of image data from the external device and storing the one or more sets of image data in the storage; and
in response to reception of an execution instruction, forming at least one image based on at least one set of the one or more sets of image data.

6. The image forming device according to claim 5, wherein the controller is configured to further perform:
receiving a selection input through the user interface, the selection input indicating a status of whether to enable or disable the storage-based image forming process,
wherein the controller performs the storage-based image forming process under a condition that the selection input indicates a status to enable the storage-based image forming process.

7. The image forming device according to claim 5, wherein the controller is configured to further perform:
receiving a selection input through the user interface, the selection input indicating a status of whether to enable or disable the storage-based image forming process;
storing status information indicating the status in the storage based on the selection input received through the user interface; and
when: the obtaining the externally configurable parameter and the storing the status information are performed; and the one or more sets of image data are stored in the storage, determining, based on the stored status information, whether to perform the storage-based image forming process,
wherein the controller performs the storage-based image forming process under a condition that the determining determines to perform the storage-based image forming process.

8. The image forming device according to claim 5, wherein the storage-based image forming process further includes:
modifying the internally controlled parameter to have a modified value based on a modification input received through the user interface in association with the execution instruction,
wherein when the modifying is performed, the controller performs the forming based on the at least one set of the one or more sets of image data and the internally controlled parameter having the modified value.

9. The image forming device according to claim 5, wherein the storage-based image forming process further includes:
receiving a designation input through the user interface, the designation input designating a target set of image data from among the one or more sets of image data; and
modifying the internally controlled parameter to have a modified value based on a modification input received through the user interface; and
wherein when the receiving the designation input and the modifying are performed, the controller performs the forming based on the target set of image data and the internally controlled parameter having the modified value.

10. The image forming device according to claim 5, wherein the controller is configured to further perform:
receiving a status input through the user interface, the status input indicating a status of whether to enable or disable modification of the internally controlled parameter;
storing, in the storage, status information indicating the status based on the status input;
in response to reception of the execution instruction to execute forming an image based on one set of the one or more sets of image data while the stored status information indicates a status to enable the modification of the internally controlled parameter, modifying the internally controlled parameter to have a modified value based on a modification input received through the user interface; and
wherein when the modifying is performed, the controller performs the forming based on the one set of the one or more sets of image data and the internally controlled parameter having the modified value.

11. The image forming device according to claim 10, wherein the controller is configured to further perform:
receiving, through the user interface, an input value in association with the status input indicating the status of whether to enable or disable modification of the internally controlled parameter; and
storing, in the storage, the input value as a value of the internally controlled parameter.

12. The image forming device according to claim 5, wherein the controller is configured to further perform:
storing, in the storage, status information indicating a status of whether to enable or disable modification of the internally controlled parameter;
when the storage stores second status information indicating a status to enable the storage-based image forming process, receiving, through the user interface, a status input, the status input indicating an updated status of whether to enable or disable the modification of the internally controlled parameter; and
updating the stored status information to indicate the updated status based on the status input.
